(19) United States
(12) Patent Application Publication
(10) Pub. No.: US 2002/0124263 A1
(43) Pub. Date: Sep. 5, 2002

(54) Internet DTV system and broadcast-station system, audience terminal, content provider device, server, and control method and storage medium

(76) Inventor: Yoshikazu Yokomizo, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/025,864

(22) Filed: Dec. 26, 2001

(30) Foreign Application Priority Data
Dec. 27, 2000 (JP) 399323/2000

(51) Int. Cl. H04N 7/025; H04N 7/10; H04N 7/173; G06F 15/16

(52) U.S. Cl. 725/112; 725/32; 709/218; 709/219; 725/131

(57) ABSTRACT

An Internet DTV system and its broadcast station system, an audience terminal, a content provider device, a server, and a control method and a storage medium, providing a bidirectional communication environment to an audience, and enabling the audience to browse contents provided from the Internet without load on the audience. For this purpose, the broadcast station delivers a program, with a description of a button to designate a second program for browsing a content. When the button is displayed in the program displayed via a set top box, the audience designates it by using a designation device such as a remote controller. When the designation is made, the Internet access is made by using an URL of content received from the broadcast station and a sponsor ID of the program. In response to this access, a content provider on the Internet notifies a commercial server of the sponsor ID, downloads a commercial for the sponsor, combines the commercial with its own managed content and transfers the content to the audience.

### FIELD OF THE INVENTION

The present invention relates to an Internet DTV broadcast system and its broadcast station system, an audience terminal, a content provider device, a server, and a control method and a storage medium.

### BACKGROUND OF THE INVENTION

Digital television broadcast is known as a technique to convert an existing analog television broadcast to digital form. According to this technique, a television broadcast, which lacks interactive communication, is close to one-way information transmission from a broadcast station. Some television receivers correspond to the Internet, however, it is inconvenient to access homepages by using a low-resolution screen in comparison with use of personal computer. There are some systems to download moving-image contents via the Internet, however, the loaded image is merely a moving image pasted in a homepage and not so attractive as a content. Thus these devices fail to provide ease of operation as that of television sets.

The drawback of Internet moving-image streaming is that if a user is interested, in the content the user accesses it and then communication is started. Accordingly, if a router lacks a broadcast function, one-to-one communication is performed.

Since the above-described television broadcast and the Internet have no connection with each other, when the user accesses the Internet, the television set is switched to the Internet connection as if it is a substitute for a personal computer. Accordingly, under the present circumstances, a television set to which an Internet-access function is simply added (so-called Web TV) is not popular. Further, as described above, as the resolution of the television screen in conformity with the general NTSC standards is low, the television screen is not appropriate for watching websites on the Internet.

### SUMMARY OF THE INVENTION

The present invention has been made in consideration of the above problems, and has its object to provide an Internet DTV system and a broadcast station system, an audience terminal, a content provider device, a server, and a control method and a storage medium, for providing a bidirectional communication environment to an audience, and enabling the audience to browse contents provided from the Internet without load on the audience.

Further, another object of the present invention is to provide an Internet DTV system and a broadcast station system, an audience terminal, a content provider device, a server, and a control method and a storage medium, for realizing an audience's entry in a realtime prize quiz game presented from the broadcast station side.

To attain the foregoing objects, the Internet DTV system of the present invention has the following construction. That is, provided is an Internet DTV system having: a digital broadcast station that broadcasts a program by using a well-known broadcast radio wave such as a ground wave or a satellite wave; a commercial server provided on the Internet that holds a content management server, managing/delivering second programs, and sponsor commercials; and a terminal, provided on the audience side, that receives a digital broadcast and accesses the Internet, wherein the broadcast station comprising: means for broadcasting information described in a predetermined format specifying the program, display of a second program to be selected by the audience, address information indicating a location of content upon selection of the second program and a sponsor of the program, and wherein the terminal comprising: means for receiving information from the broadcast station; access means for accessing the Internet; first output means for combining the received program with the second program in accordance with received description and outputting the program to a predetermined display device; input means for inputting designation information from an operator; request means for, if an input designation is related to the second program, accessing the content management server by the access means by using a described URL for the second program, notifying information to specify the sponsor, and issuing a request for transfer of the content; and second output means for outputting the content received from the content server to the display device, further wherein content management server comprising: means for, if information requested from the request means of the terminal includes information specifying the sponsor, requesting commercial information of the sponsor from the commercial server; and means for combining the commercial information sent from the commercial server with the content requested by the terminal and transmitting the information to the terminal, further wherein the commercial server comprising: a database that holds commercial contents with the information specifying the sponsor as a key; and means for searching for a corresponding commercial content from the database based on the information specifying the sponsor requested from the content management server, and notifying the commercial content to the content management server.

Further, according to a preferred aspect of the present invention, a television broadcast MPEG-2 stream reproduction image (main screen) and an Internet MPEG-4 stream reproduction image (sub screen) are displayed on the same display device (CRT) such that one program is constructed with the main screen and the sub screen correlated with each other. The MPEG-4 stream of the sub screen, introduced from the main screen, can be easily reproduced. Further, a mail-order service is provided in the sub screen in a realtime manner regarding a product introduced in the main screen. Further, an answer to a questionnaire to the audience from the main screen can be sent by simple button operation in the sub screen, and the result of summary of answers is instantly displayed in the main screen. Further, an audience rating of the main screen can be summarized by using a communication function of the sub screen in a realtime manner. Thus the main screen and the sub screen are provided in mutual conjunction. Further, in a commercial broadcast where commercials are inserted in the main screen, which is a free broadcast for the audience, a commercial also related to the main screen is inserted in the sub screen, otherwise, broadcast of commercial of at least an advertiser who is a rival of the advertiser of the main screen is avoided. A system to dynamically insert a commercial upon broadcast of sub screen is provided. Thus, a new entertainment environment of digital television (DTV) age can be provided.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an explanatory view showing an Internet DTV broadcast system according to the present invention;

FIG. 2 is an explanatory view of the flow of contents;

FIG. 3A is a block diagram showing the construction of commercial server 10;

FIG. 3B is a flowchart showing the outline of operation processing of the commercial server;

FIG. 4 is a timing chart showing a content distribution procedure;

FIG. 5 is a timing chart showing the content distribution procedure;

FIG. 6 is a timing chart showing the content distribution procedure;

FIG. 7 is a timing chart showing the content distribution procedure;

FIG. 8A is a block diagram of broadcast station system;

FIG. 8B is a flowchart showing an operation process procedure of the broadcast station system;

FIG. 9A is a block diagram of set top box;

FIG. 9B is a flowchart showing an operation process procedure of the set top box;

FIG. 10A is a block diagram of content management server;

FIG. 10B is a flowchart showing an operation process procedure of the content management server;

FIG. 11 is a block diagram of the commercial server according to a second embodiment of the present invention; and

FIG. 12 is a timing chart showing a data distribution procedure according to the second embodiment.

### DETAILED DESCRIPTION OF THE PREFERRED EMBODIMENTS

Hereinbelow, preferred embodiments of the present invention will now be described in detail in accordance with the accompanying drawings.

<First Embodiment>

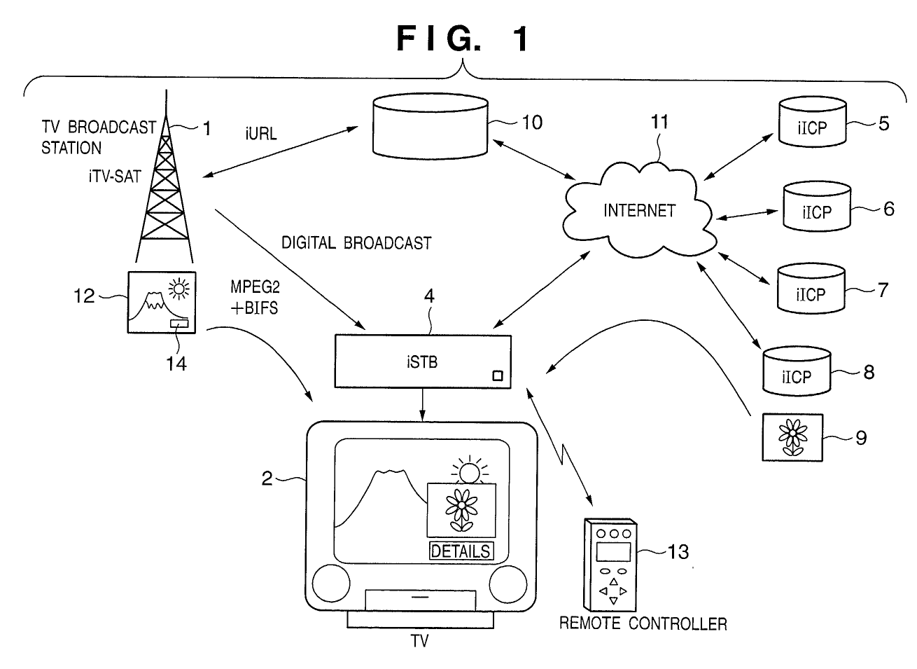

FIG. 1 shows the entire configuration of Internet DTV broadcast system according to a first embodiment of the present invention.

In FIG. 1, reference numeral 1 denotes a digital television broadcast station for broadcasting a digital moving-image content (main screen); 2, a television receiver (TV); 4, a set top box (STB) having a construction to appropriately multiplex MPEG-2 and MPEG-4 contents and distribute the content to necessary circuits, which switches the TV 2 to a satellite broadcast mode; 5 to 8, content providers (iICPs) for delivering an MPEG-4 moving-image content via the Internet to the TV 2; 9, an MPEG-4 moving-image content (for sub screen) uploaded on the iICP; 10, a commercial server which manages commercials dynamically inserted in the sub screen; 11, the Internet; and 12, a moving-image content for the main screen broadcasted from the broadcast station 1.

The television broadcast station 1 is a broadcast station corresponding to digital television broadcasting. Transmission means may be a ground wave or a satellite wave, otherwise, may be a cable-television broadcast network. In the case of the figure, a satellite wave is used as the transmission means. In the multilayer profile (scalable profile) of MPEG-2 used in the digital television broadcast standards, appropriate digital data as well as an audio signal and a video signal for the main screen 12 can be multiplexed and transmitted. For example, a still image can be sent, otherwise, the system layer of MPEG-4 can be transmitted. For example, an MPEG-4 BIFS (Binary Format for Scene) description can be transmitted. BIFS is standardized as ISO/IEC14496-1.

An object descriptor can be designated by the scene description language BIFS. Objects include a moving image, a still image, text, a sound, a button (symbol) and the like. In the present embodiment, a button object is transmitted, thereby a button object is provided in a part of the main screen 12.

As the button object, a shape, a broadcast station ID, a program ID, a sponsor ID, a business type ID, a moving image content URL, a charged/free flag, text and the like can be transmitted as well as an object descriptor ID.

The set top box (ISTB) 4, having a BIFS decoding function, easily decodes a shape object. Based on the decoded shape information, the iSTB 4 displays a button 14 in the main screen. The button 14 is selected by using a remote controller 13, and the function of the button can be performed by one click. The button 14 is linked to a URL of particular page by excellent content providers 5 to 8 selected in advance on the broadcast station side. When the button is depressed, the URL is designated, then connection by HTTP protocol is started, and sync layer is set for MPEG-4 stream transmission. MDIF (Delivery Multimedia Integration Framework) for audio-video synchronization is not indispensable, however, preferably, it is provided for stable stream reproduction with compatibility.

The most typical way of use of the Internet DTV system employed in the present embodiment is as follows. When a television program where an announcer does commentary on some topic, e.g., baseball game, is broadcasted, if the announcer says that audiences who want to know the detailed profile of the batter (e.g. (the name of the athlete “xxx”) should click the “button”, the audience can browse the detailed information on the batter (e.g. video image showing an interview) displayed on the sub screen by automatically accessing an MPEG-4 moving-image content provider by one click.

It seems that, in a case where a television broadcast is a free commercial broadcast, the audience often desires to enjoy a moving-image stream on the Internet side at no charge. To establish such free broadcast as a business, a commercial broadcast is inevitable. Audiences are accustomed to insertion of commercial in free broadcast from the television station 1. A commercial must be inserted in a small program on the sub screen presented by the provider via the Internet.

Commercials inserted in the sub screen 9 are not freely selected, but generally, a commercial by the same sponsor as that in the main screen is desirable. However, a commercial is selected case by case. If the sponsors conduct different types of businesses, commercials may be freely selected. At least a commercial of the rival of the sponsor of the main screen should not be broadcasted in the sub screen. For example, assuming that the sponsor of the main screen is “XXX”, a commercial of a rival company “YYY” cannot be broadcasted in the sub screen. The combination of commercials depends on sponsors' contract conditions.

The content providers 5 to 8 have moving image contents of their special fields (arts, nature, travel, gourmet, foreign countries, space etc.), and try to make the most of their individualities.

However, in the case of application in the present embodiment, since an infinite number of combinations of sponsors can be made between the main screen and the sub screen, it is difficult to prepare a moving image where a commercial is inserted in advance. To solve this problem, a commercial should be dynamically inserted.

It is convenient to manage the storage of commercials (commercial server) in one position rather than individually manage the storage by the respective content providers 5 to 8. The server 10 is provided for this purpose, and it is used for managing commercial videos from various companies of various businesses. The respective content providers 5 to 8 must find various commercials in response to requests from the audiences from the set top box 4. The commercial server 10 respond to such various requests. To the content providers 5 to 8, it is further advantageous that they are released from a complicated procedure to find sponsors and respectively sign a contract with the sponsors, in addition to the advantage that they are released from troublesome storage/management of commercial videos. For the sponsors, it is troublesome to respectively sign a contract with thousands of content providers in the world. The independent commercial server 10 is provided to solve this inconvenience. The server is usually managed by an independent commercial management company or advertising agency.

The settings (rules) of commercial broadcasting are as follows.

TABLE 1

| | |
|---|---|
| (1) | designate a sponsor name |
| (2) | allow if another business type |
| (3) | reject a particular company |
| (4) | allow if advertising charge is equal to or greater |
| | than a predetermined amount |
| (5) | designate date of generation of content |
| (6) | adult-only title: intended for ages under XX |
| (7) | 15 second commercial/30 second commercial/1 minute |
| | commercial |
| (8) | designate a particular field |
| (9) | content type-based limitation (passive, active, |
| | mail-order, gamble, game etc.) |

The commercial server 10 is generally preferable for an advertising agent. The commercial server automatically searches the database and immediately delivers an optimum commercial stream, based on various requests from clients (content providers 5 to 8).

It is the role of the content providers 5 to 8 to merge the commercial with the MPEG-4 moving-image content.

The role of the commercial server 10 is not only to deliver a commercial but also to manage the operation of the entire Internet DTV system. Accordingly, to examine “the audience rating of the main screen” in a realtime manner, an Internet access route is ensured.

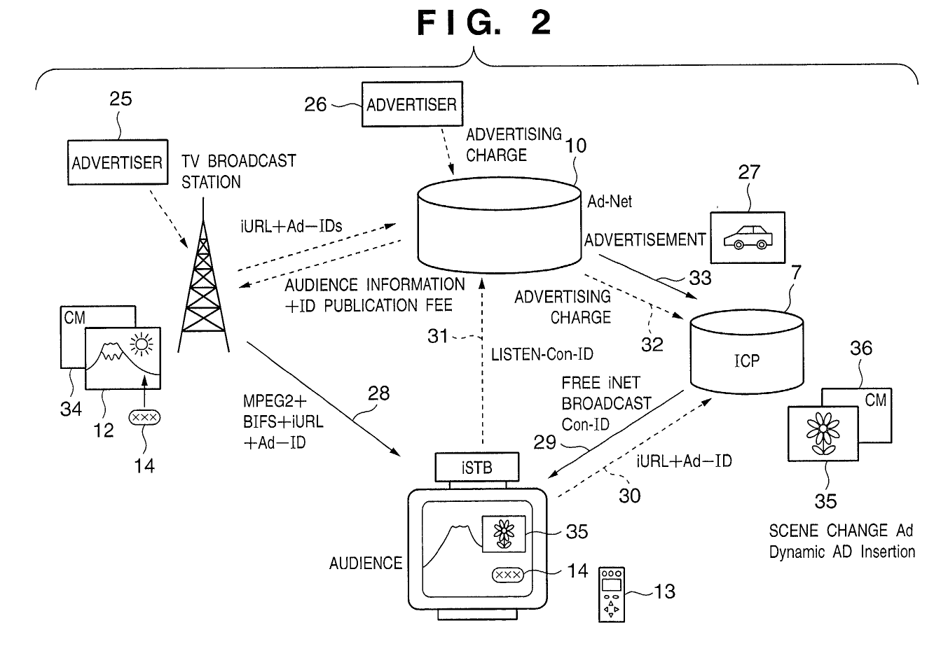

FIG. 2 shows an example of realized advertising broadcast in the Internet DTV system according to the present embodiment. In FIG. 2, constituent elements corresponding to those in FIG. 1 have the same reference numerals. In FIG. 2, the set top box (iSTB) 4 is omitted, however, the function provided by the set top box 4 is included in the TV 2. A commercial 34 inserted in the main screen by the sponsor (advertiser) 25 is inserted in an appropriate time slot of moving image content 12 by a known method. A free broadcast 28, which is free for the audience, is made by multiplexing the following information:

| | |
|---|---|
| MPEG2 | main screen moving image stream |
| BIFS | screen description |
| iURL | Internet URL of independent moving-image |
| | provider (ICP) |
| Ad-ID | advertiser ID number |

BIFS is used for describing a size, a design, a position, a name, text, URL and the like of the button 14. A desired button is displayed on the main screen based on the BIFS description. A cursor is moved by using the remote controller 15, and when the button is selected (highlighted), if a selection button on the remote controller 15 is depressed, access to the ICP provider 7 is started based on URL information of the button, and a homepage moving image 35 becomes a transmittable state. A content start signal 30 to the ICP provider includes the following information:

| | |
|---|---|
| iURL | Internet URL of independent moving-image |
| | provider (ICP) |
| Ad-ID | advertiser ID number |

The ICP provider 7 send the Ad-ID thereby requests transmission of commercial 27 related to an advertiser 25 from the server 10 of the commercial management company.

The server 10 of commercial management company checks the advertiser ID 25, examines contract conditions and the like, and transmits an appropriate commercial 27. The ICP provider 7 inserts the commercial 27 in the moving image 35 which has been divided into several blocks in advance.

The insertion of commercial may be made by actually reproducing a moving image, editing it at a bitmap stream level and recompressing it, however, this is not realtime processing. In the present embodiment, HTML description is expanded such that a commercial is equivalently inserted.

<IMG SRC=“Seam_{—}1”, “CM_{—}1”, “Seam_{—}2”, “CM_{—}2”, “Seam 3” . . . >

The browser function of the TV 2 sequentially requests the ICP provider 7 to transmit the reference moving image file, “Seam_{—}1”, “CM_{—}1”, “Seam_{—}2”, “CM_{—}2”, “Seam_{—}3” . . . described in the above expanded HTML, thus continuously reproduces them.

Commercials from a large number of advertisers are stored in the commercial server 10, and parameters of the respective commercials extracted from the contract conditions are stored in a copyright management database (IPMP-DB) to be described later. Based on a commercial transmission request from the ICP provider 7, the system of the commercial management company performs the following operations, thus automatically selects a commercial and transmits it.

(a) The copyright management database is referred to based on “desired commercial type” required from the ICP provider 7 (a condition is added to the items of Table 1), and a list of appropriate contents is outputted.

(b) A final appropriate content is found based on management information of the commercial server (narrowed-scope search with the following (2) to (5) of Table 2 as conditions).

TABLE 2

| | |
|---|---|
| (1) | content meeting above-described Table 1 |
| (2) | content designated as an emergency transmission item |
| (3) | content of which transmission schedule has gone into |
| | effect |
| (4) | content with high popularity |
| (5) | content of which the number of remaining |
| | transmission schedules is not zero |

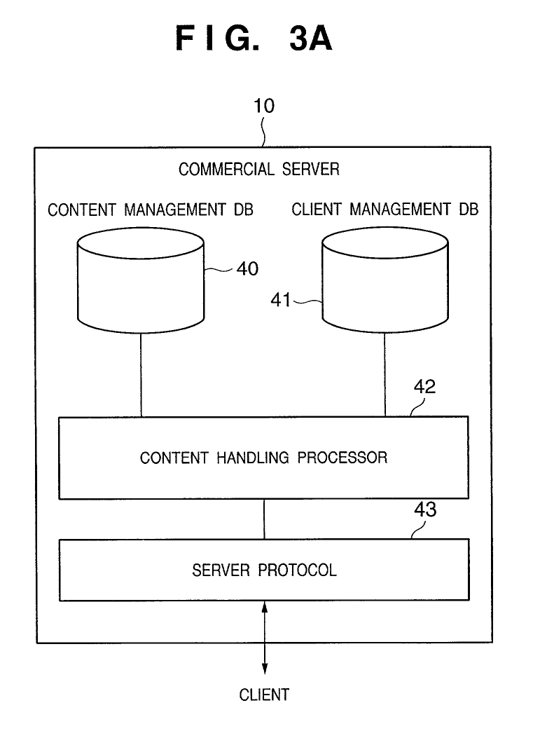

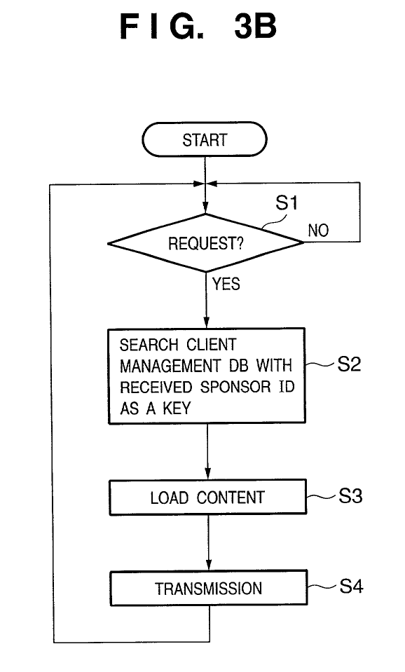

FIG. 3A shows the construction of the commercial server 10. Numeral 40 denotes a content management DB including the following data per each content:

(1) content ID

(2) content name

(3) sponsor ID

(4) sponsor name

(5) sponsor name (sponsor ID)

(6) flag to allow if another business type

(7) flag to exclude particular company

(8) advertising charge lower limit condition

(9) date of generation of content

(10) R-rated number

(11) content time length

(12) field

(13) content type-based limitation

(14) content (or pointer to content)

(15) emergency transmission flag

(16) broadcast schedule

(17) popularity

(18) number of remaining broadcast schedules

(19) time limit of use of content

(20) copyright holder ID

(21) broadcast right holder ID

Numeral 41 denotes a client management database including the following information per client:

(1) sponsor ID

(2) sponsor name

(3) responsible person's name

(4) address, telephone number, facsimile number, e-mail address

(5) number of employees

(6) field

(7) general contract conditions

flag to allow if another business type

flag to exclude particular company

R-rated number

field

flag to limit content type

Numeral 42 denotes a content handling processor (CHP) as a core module which controls the overall commercial server 10. The content handling processor plays a key role in content search. A server protocol 43 provides communication with the client (ICP).

The CHP 42 of the commercial server 10 performs processing in accordance with a procedure as shown in FIG. 3B. Note that the commercial server 10 may be a general information processing device such as a work station or a personal computer. In this case, a server program corresponding to the flowchart of the figure is installed in the device and executed there.

First, at step S1, it is checked whether or not a request has been received from the client (ICP), and if it is determined that a request has been received, the process proceeds to step S2. At step S2, the sponsor ID in designated information is extracted, and the client management DB 41 is searched with the sponsor ID as a key. As a result, the location of storage (file name with a path) of content as commercial data of the sponsor ID is found, then at step S3, the content is loaded, and at step S4, the content is transmitted to the client that has requested the content. Note that communication with the client is performed by HTTP, FTP, RPC or the like in a higher layer, and by TCP/IP, UDP/IP or the like in a lower layer.

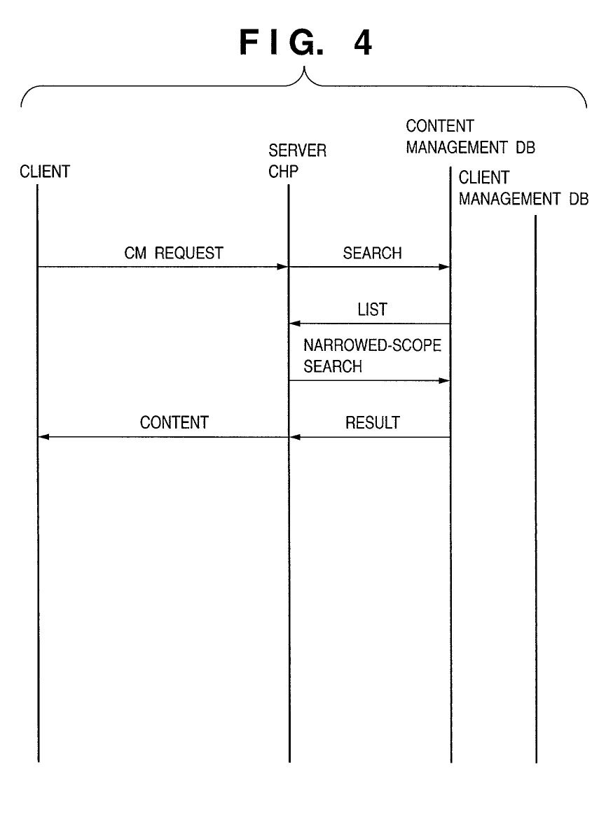

The determination of content to be transmitted will be described in more detail with reference to FIG. 4.

When a “CM request” from the client such as ICP is sent to the content handling processor (CHP) of the server, the CHP performs a search on the content management DB by a keyword included in the CM request. The result of search as a list is returned to the CHP, then the CHP performs one or more narrowed-scope search on the list, and performs streaming of an optimum content for the client. This is the basic flow of this processing, however, the sequence has several variations in accordance with information included in the “CM request” and the search result.

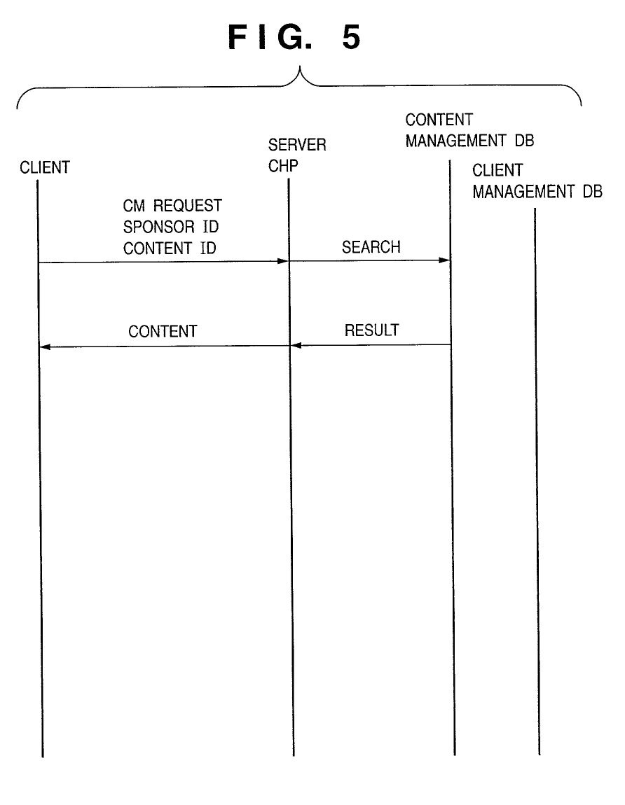

As shown in FIG. 5, in the “CM request”, if two keywords

content ID

sponsor ID

are designated, it is checked that the number of remaining broadcast schedules is not zero, and the content that has been a hit in the search is immediately broadcasted. Then the number of remaining broadcast schedules is decremented by one. If there is no hit in the search, a “no content” error is returned.

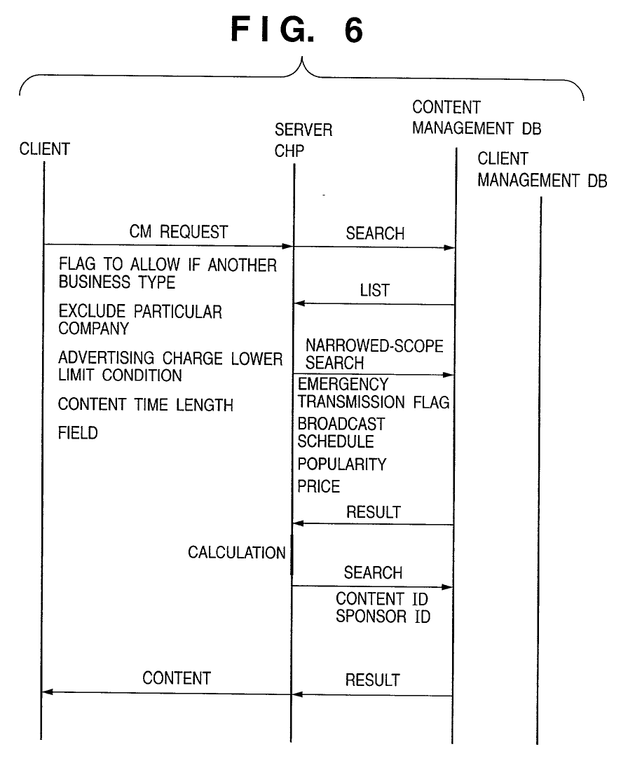

As shown in FIG. 6, in the “CM request”, if no content ID and no sponsor ID are designated, and any one or some of the conditions are set from

flag to allow if another business type

flag to exclude particular company

advertising charge lower limit condition

content time length

field

then a search is conducted to find hits meeting all the conditions. Further, a search is conducted on the obtained result to find hits meeting the following conditions:

the date of generation of content is later than the designated year and date;

R-rated number (0 to 5) is less than the designated number;

OR search is conducted on plural fields designated in limitation of content type.

the number of remaining broadcast schedules is not zero

The result of the above search is returned to the CHP. If plural hits are found, the CHP rearranges the data in accordance with the following priority order, and determines the first content.

| | |
|---|---|
| 1. emergency transmission flag (0/1) | weight 20 |
| 2. broadcast schedule has gone into effect | weight 1 |
| 3. popularity (1 to 5) | weight 2 |
| 4. price (1 to 5) | weight 1 |

These parameters, which cannot be obtained from the client, can be designated only by the content management company.

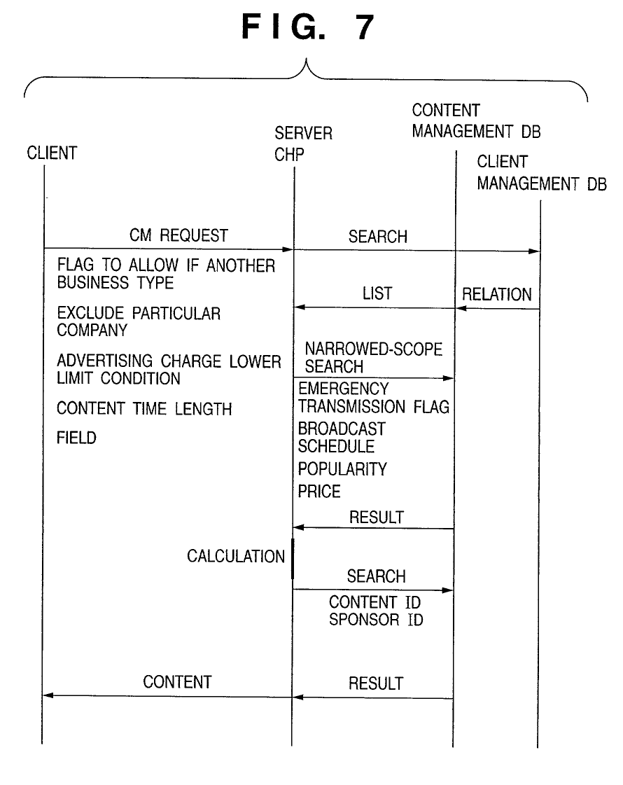

FIG. 7 is a timing chart showing a case where if a description exists in the content-based individual copyright management database, it is used, while if there is no description, a search is conducted in accordance with the general contract conditions of the client management database.

Next, a particular construction and its operation procedure of the broadcast station 1, the iSTB 4 and the iICP 5 (or 6 to 9) to realize the above processing will be described (the commercial server 10 has been previously described).

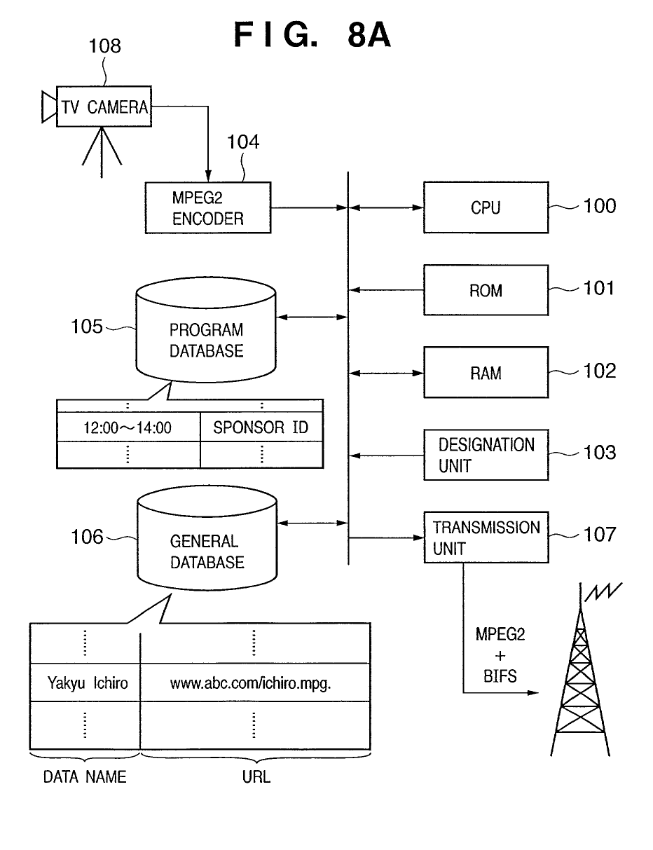

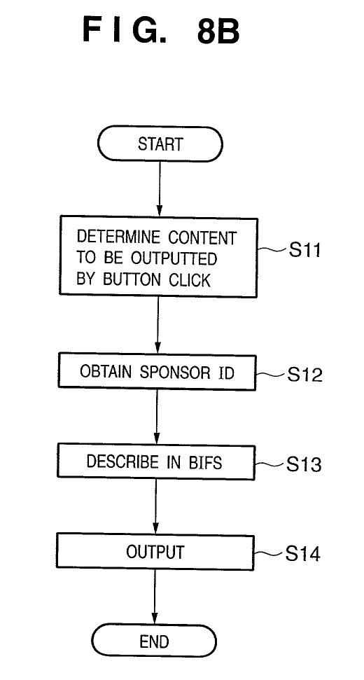

First, an example of the system set in the broadcast station 1 as shown in FIG. 8A will be described.

In FIG. 8A, numeral 100 denotes a CPU which controls the overall system; 101, a ROM in which BIOS and the like are stored; 102, a RAM which is used as a work area for the CPU 100 and in which applications are loaded; 103, a designation unit such as a keyboard or a mouse; and 104, an MPEG2 encoder which inputs video data and encodes it in MPEG2 format. In the figure, the MPEG2 encoder 104 is connected to a television camera 108, however, it may be connected to an external storage device such as a video tape recorder. Numeral 105 denotes a program database holding at least schedules of digital broadcast programs to be handled by the broadcast station and sponsor IDs indicating sponsors of the programs. In a case where one program is sponsored by plural advertisers, the IDs are separated by appropriate delimiters and stored in the database. Numeral 106 denotes a general database holding URLs of Web servers including profiles of program guests, sport athletes and the like and file names. Note that in this embodiment, the database handles information on persons, however, the database is not limited to this type of information but any type of data can be used as long as the database holds URL of the Websites where the details are stored as files. Numeral 107 denotes a transmission unit which generates data of MPEG2 (generated by the present system)+BIFS and outputs the data via an antenna to a satellite. Note that in the present embodiment, the button is displayed by BIFS description, however, it may be described in BML. Timing and description to display the button in a program on the air are made by the designation unit 103, however, it may be arranged such that the description is prepared and output time is managed in advance, and display of the button is made at the output time.

In the above construction, in the broadcast station 1, a video image obtained by the television camera 108 is encoded to MPEG2 data, and a description to display the button 14 as shown in FIG. 2 at necessary timing is embedded in the data, and the data is broadcasted. At this time, the URL and the sponsor ID downloaded from the ICP are also embedded with a linkage with the button. FIG. 8B is a flowchart showing a processing procedure of the button display in the present system.

First, at step S11, at timing to display the button for designation of display of content, the data is selected and determined from the general database 106 by using the designation unit 103. Upon completion of this processing, the process proceeds to step S12, at which the program database 105 is referred to, and the sponsor ID of the program on the air is read. Next, at step S13, the URL and the sponsor ID of the selected content are described in BIFS, and at step S14, the data is outputted with the video image as a stream.

Next, a particular construction and operation of the iSTB (set top box) 4 will be described.

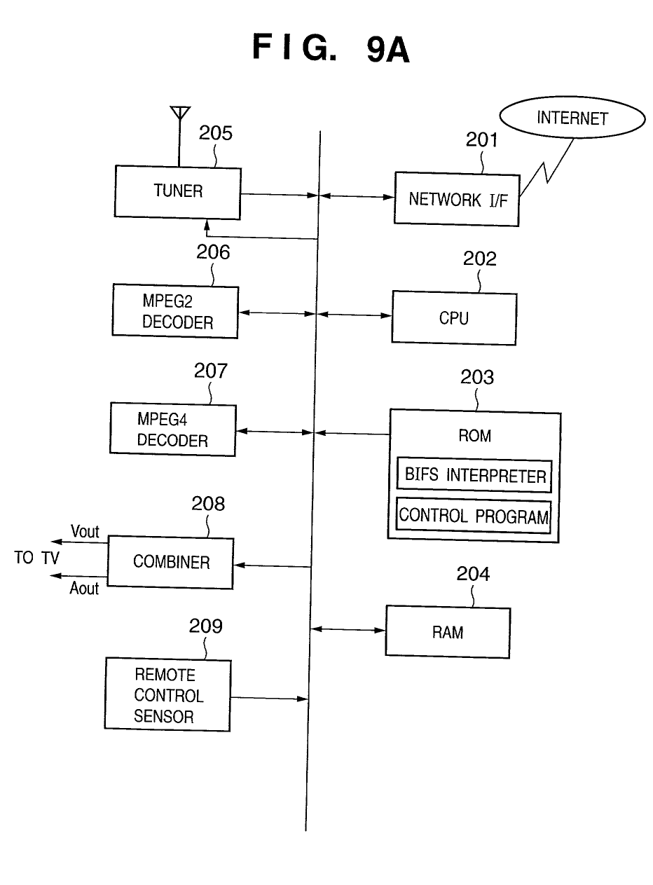

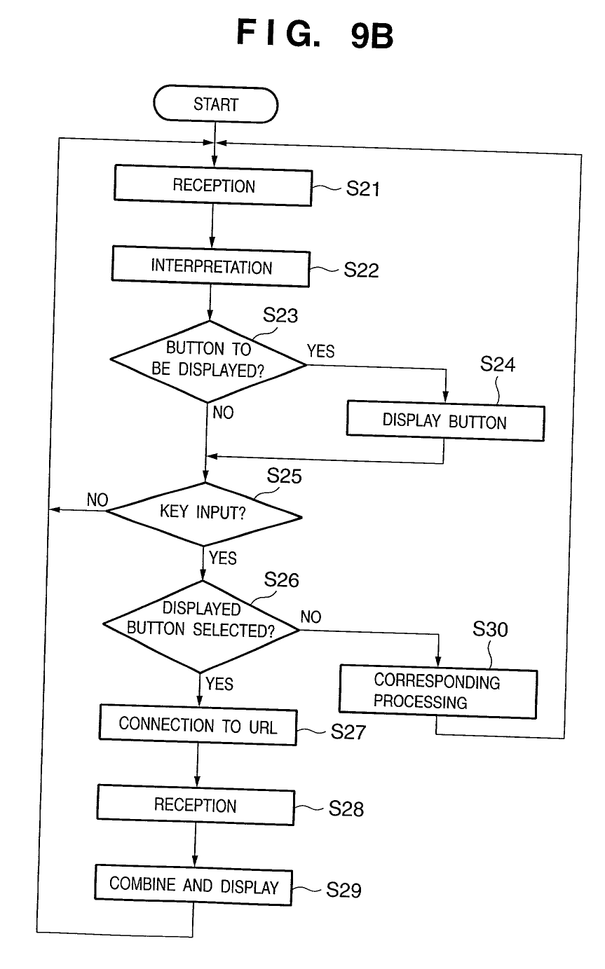

FIG. 9A is a block diagram showing the construction of the iSTB 4 in the present embodiment. In FIG. 9A, numeral 201 denotes a network interface to be connected to the Internet (iICPs 5 to 8 in the present embodiment). As typical hardware, the interface 201 is a MODEM (cable MODEM), a TA, a dialup router (broadband router) or the like. Connection is made based on the TCP/IP protocol. Numeral 202 denotes a CPU which controls the hardware of the overall apparatus; 203, a ROM in which operation process procedures of the CPU 202 are stored. Fonts, a BIFS interpreter and a control program to control hardware and communication, as shown in the figure, are stored in the ROM 203. Numeral 204 denotes a RAM used as a work area for the CPU 202; 205, a tuner for reception of digital broadcast; 206, an MPEG2 decoder which decodes MPEG2 data (broadcasted program); 207, an MPEG4 decoder which decodes MPEG4 data (content including a commercial transferred from the iICP) downloaded from the Internet; 208, a combiner which combines the image and audio data obtained by decoding by the MPEG2 decoder 206 or the MPEG4 decoder 207 and supplies the data to the TV 2; and 209, a remote control sensor which performs communication with the remote controller 13.

In the above construction, the CPU 202 interprets the BIFS description obtained by the tuner 205, decodes a video part in the obtained data by the MPEG2 decoder 206, generates a button image if a description for the above-described button display exists in the data, then outputs the data to the combiner 208 so as to overlay the data with the video image.

FIG. 9B shows an operation process procedure of the CPU 202 in the above construction. Hereinbelow, the procedure will be described with reference with the flowchart of FIG. 9B.

First, at step S21, a program is received by the tuner 205. At step S22, the program is interpreted by the BIFS interpreter. Note that video data is subjected to decoding by the MPEG2 decoder 206 and combining processing by the combiner 208, and is outputted to the TV2.

At step S23, it is determined whether or not there is a description for button display (whether or not there is a description of environment designated by a user). If NO, the process proceeds to step S25, at which it is determined whether or not there is designation from the remote controller 13, and if NO, the process returns to step S21 to repeat the above processing.

During the above processing, if there is a description of button display (including a URL description), the process proceeds from step S23 to step S24, at which images of the button and a message (character string) to be overlay-displayed are generated, and outputted to the combiner 208, thereby a message “select this button if you want to browse the details of xxx” or the like and the button are displayed on the TV screen.

On the other hand, if it is determined that an operation has been made by using the remote controller 13, the process branches off from step S25 to step S26, at which it is determined whether or not the operation relates to selection of displayed button (if the button is displayed). If NO, i.e., if the operation is made for channel change, volume change, cursor movement or the like, the process proceeds to step S30, at which corresponding processing is performed. If YES, the process proceeds to step S27, at which a transfer request is issued to the iICP in accordance with the URL (including content ID=content file name) transmitted from the broadcast station. At this time, as described above, at least the sponsor ID information is also notified to the iICP.

As a result, the designated content (with a commercial) is sent from the iICP, then at step S28, the content is received and decoded by the MPEG4 decoder 207. At step S29, the decoded image data is outputted to the combiner 208, thereby the image is displayed as a sub screen image on the display screen of the TV2.

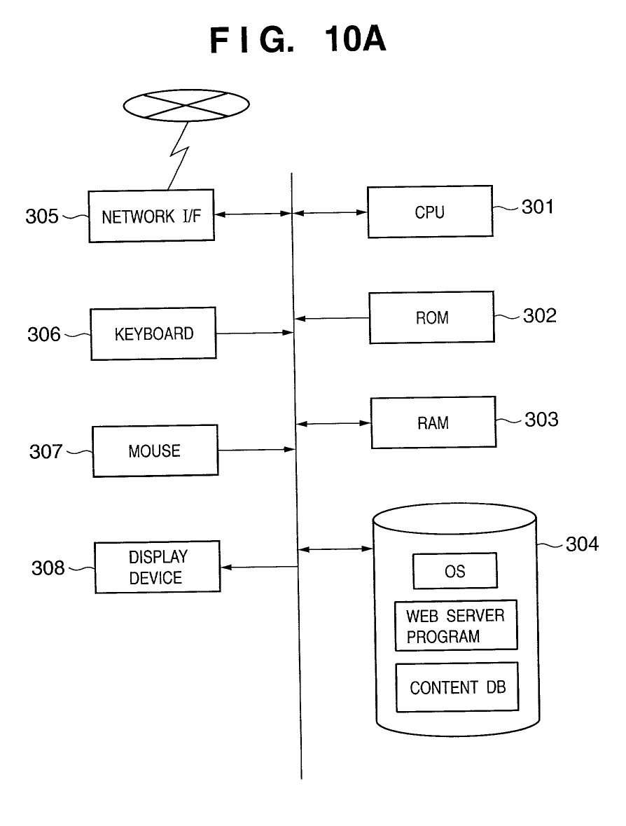

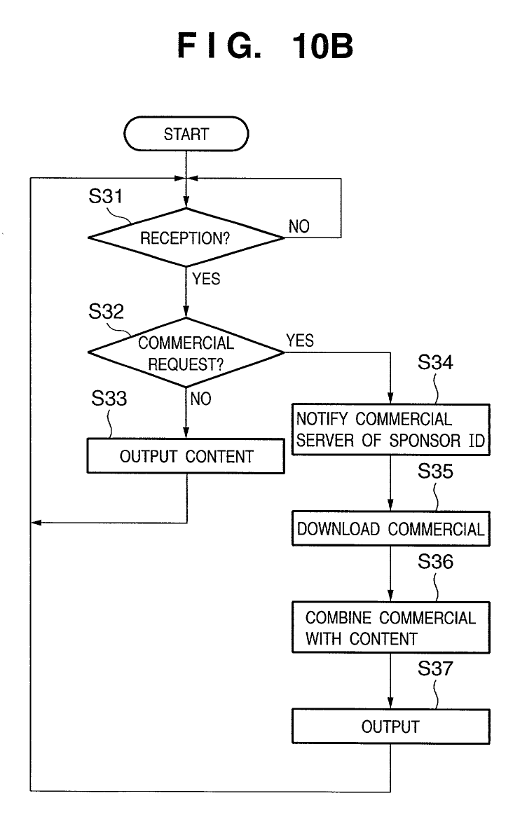

Next, the construction and operation of the iICP will be described. FIG. 10A is a block diagram of the iICPs 5 to 8 in the present embodiment. In the present embodiment, the iICP is a general information processing device such as a work station or a personal computer.

In FIG. 10A, numeral 301 denotes a CPU which controls the overall device; 302, a ROM in which a boot program, BIOS and the like are stored; 303, a RAM used as a work area for the CPU 301, in which a program which functions as the OS and the iICP is loaded and executed; 304, a hard disk in which a Web server program which functions as the OS and the iICP, further, a content DB which manages contents, are stored; and 305, a network interface for connection with the Internet. Communication with the iSTB and the commercial server is performed via the network interface 305. Numeral 306 denotes a keyboard; 307, a mouse; and 308, a display device.

In the above construction, an operation procedure of the iICP (Web server program) is performed in accordance with a procedure as shown in FIG. 10B.

First, at step S31, it is determined whether or not a request has been received from the iSTB. If it is determined that a request has been received, the process proceeds to step S32, at which it is determined whether or not the request includes a commercial request (normally, the request is not made by other devices than the ISTB such as a personal computer). If NO, the process proceeds to step S33, at which a search is performed on the content DB for the designated content, and the result of search is transferred via the network interface to the request originator.

On the other hand, if it is determined at step S32 that there is a commercial request, the process proceeds to step S34, at which information including the sponsor ID is notified to the commercial server 10, and at step S35, commercial data is downloaded. Then at step S36, the designated content and the downloaded commercial are combined (e.g., the commercial is inserted in the head or appropriate portion of the content). At step S37, the resulted data is transmitted to the iSTB as the request originator.

As described above, according to the present embodiment, in the Internet DTV broadcast system, a one-way television broadcast by existing mass media is combined with a broadcast from grass-roots small-to-medium-size broadcast stations via the Internet, and a previously-selected excellent content is introduced. Accordingly, the audience can enjoy a reliable secondary program. Further, as a commercial of the sponsor of the main screen (program from the broadcast station) can be outputted at the same time, display of commercial of rival company can be avoided.

Note that as described above, since the broadcast station, the iICP and the commercial server are respectively general information processing devices, their functions can be realized by supplying programs from the outside. In other words, the present invention can be realized by storing a program into a storage medium (floppy disk, a CD-ROM or the like) and installing the medium in a system or apparatus. Accordingly, such storage medium is also included in the present invention.

Further, the iSTB 4 has the MPEG decoder as hardware, however, since these devices are realized by software, the present invention is not limited to the above construction.

<Second Embodiment>

In addition to the feature of the above-described first embodiment, the second embodiment has a feature that a user (audience) can take part in a program in an interactive manner. As an example, a prize CM will be described.

Generally, in a television broadcast, when the broadcast station side conducts a prize campaign or questionnaire, an audience writes an answer on a postcard and send it to the broadcast station. However, it is troublesome and the audience often abandons sending the answer from the start. Accordingly, the second embodiment provides a system for enabling audiences to send an answer, which seems to be a correct answer of e.g. a prize quiz, by a simple operation such as depression of a button of the remote controller 13.

For the sake of simplification of explanation, in this example, the iSTB 4 holds a mailing program. Further, an iSTB 4 address of each user (mail addresses and actual addresses, registered names and the like) is managed by the commercial server 10 as a client management DB. Accordingly, as it is convenient to use the commercial server 10 as a server to answer to e.g. a prize quiz, in the second embodiment, entries from the users are received by the commercial server 10. Note that the commercial server 10 is merely used as an example of such reception server, but any other server may be used.

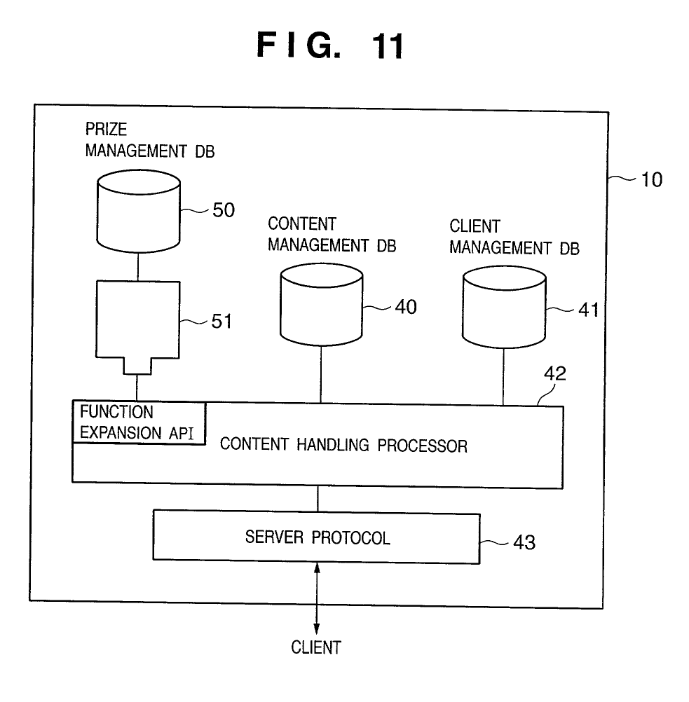

FIG. 11 shows the construction of a server to realize transmission of the prize CM according to the second embodiment. The difference from FIG. 3A is that a prize management database 50 and a prize data handling function expansion module (hereinafter prize plug-in) 51 are provided.

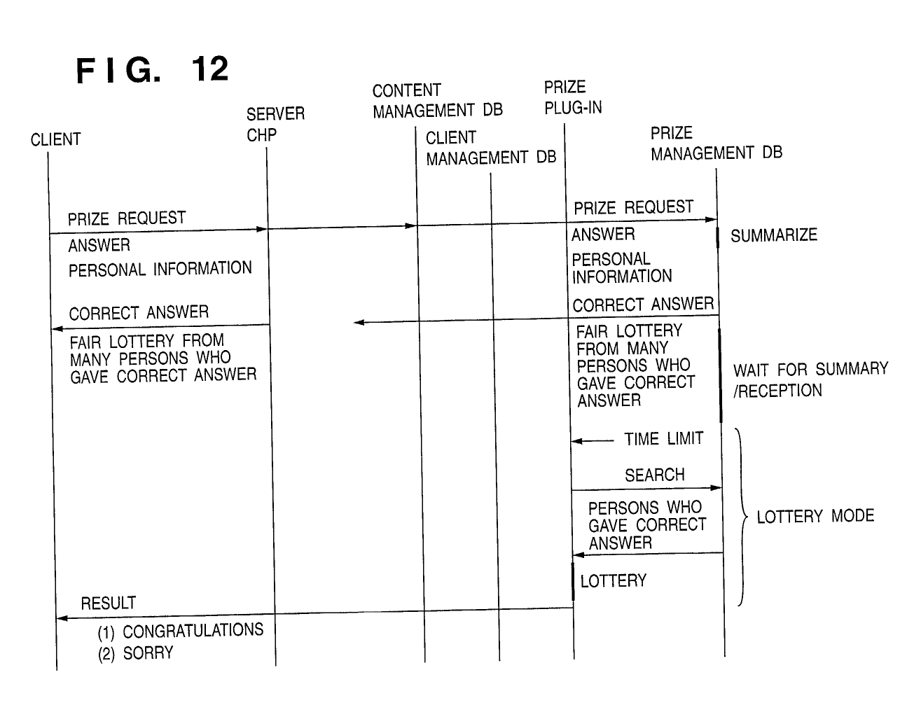

FIG. 12 is a timing chart showing the operation of the transmission. When the audience selects one of answer candidates of the quiz displayed on the TV screen (except that plural buttons are displayed, the selection of button is the same as that of the first embodiment), an IDs and numbers of prize request and the selected button are sent to the CHP server of a destination described in BIFS (server 10 in this example). The prize request has information on the selected answer and personal information on address, name and the like. The CHP server directly sends the command via the prize plug-in 51 to the prize management database 50. The data are summarized there, and answers and personal information are stored in the prize management database. A correct answer message is returned to the answerers. Generally it is conceivable that a large number of audiences gave a correct answer, accordingly, the process waits for reception of prize requests in a predetermined period.

Then, an interrupt by a time-limit timer occurs in the prize plug-in, and the process moves to a lottery mode.

The prize plug-in 51 performs a search for audiences who gave the correct answer, and selects an answerer at random from the obtained list. Note that actually, a procedure of selecting an answer from entries at random, and then, if the answer is not correct, searching for the next entries, is repeated until a predetermined number of “correct answers” are obtained. Generally, the prize is delivered by manual work.

The personal data of the summarized entries are processed in various data by using database access techniques, then returned to the TV broadcast station 1, and an average image of the answerers, the rate of correct answer and the like are dynamically projected in the program in a realtime manner.

Accordingly, the system on the broadcast station side merely accesses the commercial server 10, downloads the result of lottery (name of selected audience (registered name) and brief address information on state and city/town/village) and projects it as a subtitle in the program. Otherwise, the server 10 itself sends information on success in the lottery to a prize winner (e.g. an e-mail), and displays the result on the sub screen. In this case, the iSTB 4 receives the information, combines and displays the data.

Note that as plural programs may provide various prize quizzes, the server 10 must specify a prize quiz corresponding to an answer. On the broadcast station side, upon broadcast of prize quiz, an ID specifying the prize quiz in BIFS is embedded in the data. The ID is notified to the server 10 when the iSTB 4 is operated, and the server 10 refers to the received ID thereby determines the prize quiz.

Accordingly, it is necessary to provide the system for the server 10 and the broadcast station 1 with a function for communication between the server and the station via the Internet.

On the broadcast station side, when a new prize quiz is set, the new prize quiz can be merely registered in the server 10. Upon registration, a correct answer, the number of prize winners, deadline time are notified and registered in the prize management DB of the server 10. When the server 10 receives a request for registration of prize quiz, the server issues an ID of the prize quiz and notifies the broadcast station of the ID.

As a result of the above processing, when a prize quiz is displayed during a program, the audience side can answer it in a realtime manner, and further, can obtain the result of lottery on the spot.

Note that in the second embodiment, since the broadcast station, the iICP and the commercial server are respectively general information processing devices, their functions can be realized by supplying programs from the outside. In other words, the present invention can be realized by storing a program into a storage medium (floppy disk, a CD-ROM or the like) and installing the medium in a system or apparatus. Accordingly, such storage medium is also included in the present invention.

Especially, if a hardware device such as a digital broadcast reception tuner is installed in a personal computer, and a function of accessing the Internet and a function of decoding by software are provided in the computer, the TV receiver and the iSTB can be constructed with the personal computer.

As described above, according to the present invention, it is possible to provide a bidirectional communication environment to audiences and enable the audiences to browse contents provided from the Internet without load on the audiences.

Further, the audiences can take part in a prize quiz presented by the broadcast station in a realtime manner.

As many apparently widely different embodiments of the present invention can be made without departing from the spirit and scope thereof, it is to be understood that the invention is not limited to the specific embodiments thereof except as defined in the appended claims.

What is claimed is:

1. An Internet DTV system having: a digital broadcast station that broadcasts a program by using a well-known broadcast radio wave such as a ground wave or a satellite wave; a commercial server provided on the Internet that holds a content management server, managing/delivering second programs, and sponsor commercials; and a terminal, provided on the audience side, that receives a digital broadcast and accesses the Internet,
wherein said broadcast station comprising:
means for broadcasting information described in a predetermined format specifying the program, display of a second program to be selected by the audience, address information indicating a location of content upon selection of said second program and a sponsor of said program,
and wherein said terminal comprising:
means for receiving information from said broadcast station;
access means for accessing said Internet;
first output means for combining the received program with said second program in accordance with received description and outputting the program to a predetermined display device;
input means for inputting designation information from an operator;
request means for, if an input designation is related to said second program, accessing said content management server by said access means by using a described URL for said second program, notifying information to specify said sponsor, and issuing a request for transfer of said content; and
second output means for outputting the content received from said content server to said display device,
further wherein content management server comprising:
means for, if information requested from said request means of said terminal includes information specifying said sponsor, requesting commercial information of said sponsor from said commercial server; and
means for combining the commercial information sent from said commercial server with the content requested by said terminal and transmitting the information to said terminal,
further wherein said commercial server comprising:
a database that holds commercial contents with said information specifying said sponsor as a key; and
means for searching for a corresponding commercial content from said database based on said information specifying said sponsor requested from said content management server, and notifying the commercial content to said content management server.

2. The Internet DTV system according to claim 1, wherein said terminal further comprises:
an MPEG2 decoder for a digital broadcast;
means for interpreting a BIFS description as a scene description; and
means for decoding MPEG4 data from said content management server.

3. The Internet DTV system according to claim 1, wherein said terminal has a form of set top box connected to a television receiver owned by the audience.

4. A broadcast station system for delivering a program as digital information to a digital broadcast receiver having an Internet access function, comprising:
means for broadcasting information described in a predetermined format specifying the program, display of a second program to be selected by an audience, address information indicating a location of content upon selection of said second program and a sponsor of said program.

5. The broadcast station system according to clam 4, further comprising a database that holds broadcast times of programs and relations between sponsors and the programs.

6. A broadcast station system control method for delivering a program as digital information to a digital broadcast receiver having an Internet access function, comprising:
a step of broadcasting information described in a predetermined format specifying the program, display of a second program to be selected by an audience, address information indicating a location of content upon selection of said second program and a sponsor of said program.

7. A storage medium holding a program that functions as a broadcast station system for delivering a program as digital information to a digital broadcast receiver having an Internet access function, wherein said program including:
program code of process for broadcasting information described in a predetermined format specifying the program, display of a second program to be selected by an audience, address information indicating a location of content upon selection of said second program and a sponsor of said program.

8. A terminal having an Internet access function, provided on the audience side, for receiving a digital broadcast and outputting a video signal to a predetermined display device, comprising:
means for receiving information from a broadcast station;
access means for accessing the Internet;
first output means for combining the received program with a second program in accordance with a received description, and outputting the program to said predetermined display device;
input means for inputting designation information from an operator;
request means for, if an input designation is related to said second program, accessing said content management server by said access means by using a described URL for said second program, notifying information to specify said sponsor, and issuing a request for transfer of said content; and
second output means for outputting content received from said content server to said display device.

9. A control method for a terminal having an Internet access function, provided on the audience side, for receiving a digital broadcast and outputting a video signal to a predetermined display device, comprising:
a step of receiving information from a broadcast station;
a first output step of combining the received program with a second program in accordance with a received description, and outputting the program to said predetermined display device;
an input step of inputting designation information from an operator;
a request step of, if an input designation is related to said second program, accessing said content management server by said access means by using a described URL for said second program, notifying information to specify said sponsor, and issuing a request for transfer of said content; and
a second output step of outputting content received from said content server to said display device.

10. A storage medium holding a program that functions as a terminal having an Internet access function, provided on the audience side, for receiving a digital broadcast and outputting a video signal to a predetermined display device, wherein said program including:
program code of process for receiving information from a broadcast station;
program code of first output process for combining the received program with a second program in accordance with a received description, and outputting the program to said predetermined display device;
program code of input process for inputting designation information from an operator;
program code of request process for, if an input designation is related to said second program, accessing said content management server by said access means by using a described URL for said second program, notifying information to specify said sponsor, and issuing a request for transfer of said content; and
program code of second output process for outputting content received from said content server to said display device.

11. A content management server for transferring a content in response to a request from a terminal having an Internet access function, provided on the audience side, for receiving a digital broadcast and outputting a video signal to a predetermined display device, comprising:
a content database that holds and manages contents;
first reception means for receiving information specifying the content and information specifying a sponsor from said terminal;
second reception means for, based on the information specifying the sponsor received by said first reception means, requesting transfer of commercial content corresponding to the sponsor from a predetermined commercial server provided on the Internet, and receiving the commercial content; and
transmission means for extracting the content requested from said terminal, from said database, combining the content with the commercial content received by said second reception means, and transmitting the content to said terminal.

12. A control method for a content management server for transferring a content in response to a request from a terminal having an Internet access function, provided on the audience side, for receiving a digital broadcast and outputting a video signal to a predetermined display device, comprising:
a first reception step of receiving information specifying the content and information specifying a sponsor from said terminal;
a second reception step of, based on the information specifying the sponsor received at said first reception step, requesting transfer of commercial content corresponding to the sponsor from a predetermined commercial server provided on the Internet, and receiving the commercial content; and
a transmission step of extracting the content requested from said terminal, from said database, combining the content with the commercial content received at said second reception step, and transmitting the content to said terminal.

13. A storage medium holding a program for a content management server for transferring content in response to a request from a terminal having an Internet access function, provided on the audience side, for receiving a digital broadcast and outputting a video signal to a predetermined display device, wherein said program including:
program code of first reception process for receiving information specifying the content and information specifying a sponsor from said terminal;
program code of second reception process for, based on the information specifying the sponsor received at said first reception process, requesting transfer of commercial content corresponding to the sponsor from a predetermined commercial server provided on the Internet, and receiving the commercial content; and
program code of transmission process for extracting the content requested from said terminal, from said database, combining the content with the commercial content received at said second reception process, and transmitting the content to said terminal.

14. An Internet DTV system having: a digital broadcast station that combines a program with a second program to be overlay-displayed on said program in a predetermined description and broadcasts the program; a terminal, provided on the audience side, that receives a digital broadcast and accesses the Internet; and a server that communicates with said terminal via said Internet,
wherein said broadcast station comprising:
means for broadcasting information described in a predetermined format specifying the program, display of a second program, and address information indicating a location of a server summarizing answers from audiences upon selection of said second program,
further wherein said terminal comprising:
means for receiving information from said broadcast station;
access means for accessing said Internet;
first output means for combining a received program with said second program in accordance with a received description, and outputting the program to a predetermined display device;
input means for inputting designation information from an operator; and
notification means for, if an input designation is related to said second program, notifying said server of operated content by using an address described for said second program,
further wherein said server comprising:
determination means for, upon reception of notification from said notification means of said terminal, summarizing said notification and determining success or failure by lottery.

15. The Internet DTV system according to claim 14, wherein the result of determination is transmitted to said broadcast station and displayed in the program that is being broadcasted.

16. The Internet DTV system according to claim 14, wherein the result of determination is notified to a terminal that sent the designation information.

17. A broadcast station system for delivering a program as digital information to a digital broadcast receiver having an Internet access function, comprising:
means for broadcasting information described in a predetermined format specifying the program, display of a second program calling for audience's entry and selection in a prize quiz, and address information indicating a location of a server to receive a selected content upon selection of said second program.

18. A broadcast station system control method for delivering a program as digital information to a digital broadcast receiver having an Internet access function, comprising:
a step of broadcasting information described in a predetermined format specifying the program, display of a second program calling for audience's entry and selection in a prize quiz, and address information indicating a location of a server to receive a selected content upon selection of said second program.

19. A storage medium holding a program for a broadcast station system for delivering a program as digital information to a digital broadcast receiver having an Internet access function, wherein said program including:
program code of process for broadcasting information described in a predetermined format specifying the program, display of a second program calling for audience's entry and selection in a prize quiz, and address information indicating a location of a server to receive a selected content upon selection of said second program.

20. A server for prize quiz for receiving information via the Internet, from a terminal having an Internet access function, provided on the audience side, for receiving a digital broadcast and outputting a video signal to a predetermined display device, comprising:
reception means for, upon broadcast of a program calling for an answer to a prize quiz or the like, receiving a selected answer from said terminal; and
success determination means for summarizing received answers, and determining a predetermined number of entries by lottery.

21. The server according to claim 20, wherein the result of success determination by said success determination means is notified to the broadcast station.

22. The server according to claim 20, wherein the result of success determination by said success determination means is notified to a terminal that sent the answer.

23. A control method for a server for prize quiz for receiving information via the Internet, from a terminal having an Internet access function, provided on the audience side, for receiving a digital broadcast and outputting a video signal to a predetermined display device, comprising:
a reception step of, upon broadcast of a program calling for an answer to a prize quiz or the like, receiving a selected answer from said terminal; and
a success determination step of summarizing received answers, and determining a predetermined number of entries by lottery.

24. A storage medium holding a program for a server for prize quiz for receiving information via the Internet, from a terminal having an Internet access function, provided on the audience side, for receiving a digital broadcast and outputting a video signal to a predetermined display device, wherein said program including:
program code of reception process for, upon broadcast of a program calling for an answer to a prize quiz or the like, receiving a selected answer from said terminal; and
program code of success determination process for summarizing received answers, and determining a predetermined number of entries by lottery.
